(19) United States
(12) Patent Application Publication
(10) Pub. No.: US 2008/0302308 A1
(43) Pub. Date: Dec. 11, 2008

(54) ANIMAL THERAPY SYSTEM AND RELATED ARTICLE AND METHOD

(76) Inventor: Wendy Supino, Lake Mary, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/134,096

(22) Filed: Jun. 5, 2008

Related U.S. Application Data
(60) Provisional application No. 60/942,143, filed on Jun. 5, 2007.

(51) Int. Cl. A01K 29/00

(52) U.S. Cl. 119/174

(57) ABSTRACT

An animal therapy system includes an animal therapy article and a scented article disposed therein. The animal therapy article includes a body defining an inner volume and an opening in communication with the inner volume. The body has a closure for releasably closing the opening and filling arranged in the inner volume. A pouch is also arranged in the inner volume and is at least partially removable from the body through the opening. The scented article is removably disposed within the pouch. An animal therapy method includes scenting an article with a scent familiar to an animal, opening a closure on an animal therapy article having a pouch disposed internally thereto, at least partially withdrawing the pouch through the opened closure, inserting the scented article into the animal therapy article within the pouch, closing the closure, and placing the animal therapy article adjacent to the animal.

### CROSS-REFERENCE TO RELATED APPLICATION

This application claims the benefit of U.S. Provisional Application Ser. No. 60/942,143, filed on Jun. 5, 2007, the contents of which are hereby incorporated by reference in their entirety.

### FIELD OF THE INVENTION

The present invention relates to animal therapy, and more particularly, to articles and methods employed in connection with animal therapy.

### BACKGROUND OF THE INVENTION

Animals, particularly pets, have long been appreciated for their appearance, behavior, companionship and other qualities. Several medical studies have documented how companion animals can significantly relieve stress and anxiety in their human counterparts.

More recently, increased attention and worth has been accorded to animals, in their own right, rather than simply for the benefits they can provide to humans. This trend has led to a new appreciation that many animals are, themselves, capable of experiencing stress and anxiety. For instance, as with humans, placement of animals in new or unfamiliar surroundings can result in greatly increased stress and anxiety.

Again, as with humans, this stress and anxiety can be very detrimental to the animals' well-being. For example, many veterinary procedures require a pet, such as a dog or cat, to stay one or more nights in a veterinary hospital or clinic. In such a situation, in addition to the problems inherent in stress and anxiety, the pet's ability to properly respond to treatment or quickly heal from a procedure can be compromised.

In another example, when travel requires a pet owner to leave a pet with a friend, in a kennel, or other strange location, the pet's stress and anxiety can make the pet difficult to manage, as well as adversely impact the pet's eating and waste elimination habits.

Various attempts have been made to reduce or eliminate the stresses experienced by pets or other animals. One example can be found in U.S. Patent Application Publication No. 2007/0220674, in which a blanket is provided with a pocket into which a pad is inserted. Prior to insertion the pad is scented through contact with a user.

While the '674 publication mentions the possibility for use with pets, the blanket of the '674 publication is less suitable in many animal applications. For example, removal and subsequent destruction of the pad through the pocket by animals may easily occur. Moreover, the pocket is not well suited for use with any object other than the custom pads. Additionally, for many pets, carrying a blanket in the mouth represents a tripping hazard and presents a high likelihood of rapidly deteriorating or dirtying the blanket. Also, many pets will not consent to be wrapped in a blanket and the blanket would offer very little padding underneath any portion of the pet.

### SUMMARY OF THE INVENTION

Based on the foregoing, it is an object of the present invention to provide an improved animal therapy system, including an animal therapy article and related method of use.

According to an embodiment of the present invention, an animal therapy system includes an animal therapy article and a scented article disposed therein. The animal therapy article includes a body defining an inner volume and an opening in communication with the inner volume. The body has a closure for releasably closing the opening and filling arranged in the inner volume. A pouch is also arranged in the inner volume and is at least partially removable from the body through the opening. The scented article is removably disposed within the pouch.

According to an aspect of the present invention, the body has a neck portion with a circumference and a length, and the neck portion length is at least approximately 10 percent of the neck portion circumference.

According to another aspect of the present invention, the closure is a hook and loop closure having a hook tape with a hook surface and a reverse surface and a loop tape with a loop surface and a reverse surface, and the pouch is attached to the reverse surface of the hook tape.

According to a further aspect of the present invention, the pouch is formed of a material substantially insusceptible to gripping by the hook surface.

According to a method aspect, the present invention includes scenting an article with a scent familiar to an animal, opening a closure on an animal therapy article having a pouch disposed internally thereto, at least partially withdrawing the pouch through the opened closure, inserting the scented article into the animal therapy article within the pouch, closing the closure, and placing the animal therapy article adjacent to the animal.

It will be appreciated that various embodiments and aspects of the present invention allows use of a filled body more useful and practical to animals, allow use of a wider range of scented articles, provide greater protection and concealment for the scented articles, and facilitate the insertion and removal of the scented articles.

These and other objects, aspects and advantages of the present invention will be better appreciated from the drawings and following description of preferred embodiments.

### BRIEF DESCRIPTION OF THE DRAWINGS

FIG. 1 is a schematic front view of an animal therapy system including an animal therapy article and a scented article, with hidden components and directional indications shown in broken lines and a component partially cut away to show details, according to an embodiment of the present invention;

FIG. 2 is a partial rear view of the animal therapy system of FIG. 1, with a closure on a body of the animal therapy article shown in a closed position;

FIG. 3 is a partial rear view of the animal therapy system of FIG. 1, with the closure on the body of the animal therapy article shown in an open position;

FIG. 4 is a sectional view taken along line 4-4 of FIG. 2;

FIG. 5 is a sectional view taken along line 5-5 of FIG. 3; and

FIG. 6 is a sectional view of an alternate closure configuration, according to another embodiment of the present invention.

### DETAILED DESCRIPTION OF PREFERRED EMBODIMENTS

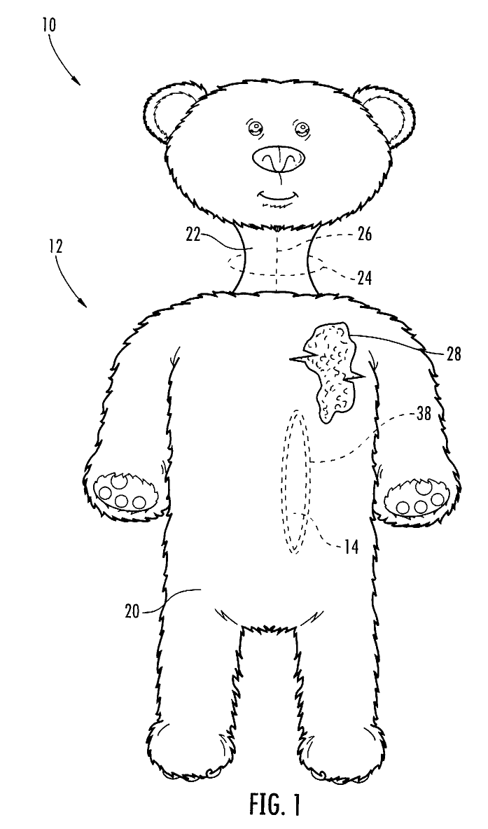

Referring to FIG. 1, according to an embodiment of the present invention, an animal therapy system 10 includes an animal therapy article 12 with a scented article 14 disposed therein. The animal therapy article 12 includes a body 20 that defines an interior volume.

The body 20 has a neck portion 22 having a circumference 24 and length 26. Advantageously, the neck portion length 26 is at least approximately ten percent of the circumference 24. Most advantageously, the length 26 is approximately one-eighth of the circumference. The body 20 is also stuffed with filling 28 (revealed by partial cutaway).

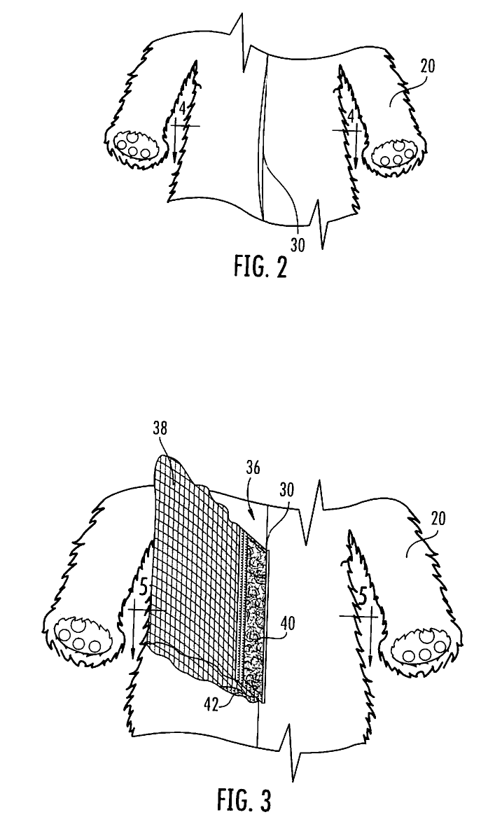

Referring to FIGS. 2 and 3, the body 20 defines an opening 30 communicating with the inner volume. A closure 36 releasably closes the opening 30. A pouch 38 is arranged within the inner volume and is at least partially removable from the body 20 through the opening 30. When inside the body 20, the scented article 14 is removably disposed within the pouch 38 (see FIG. 1).

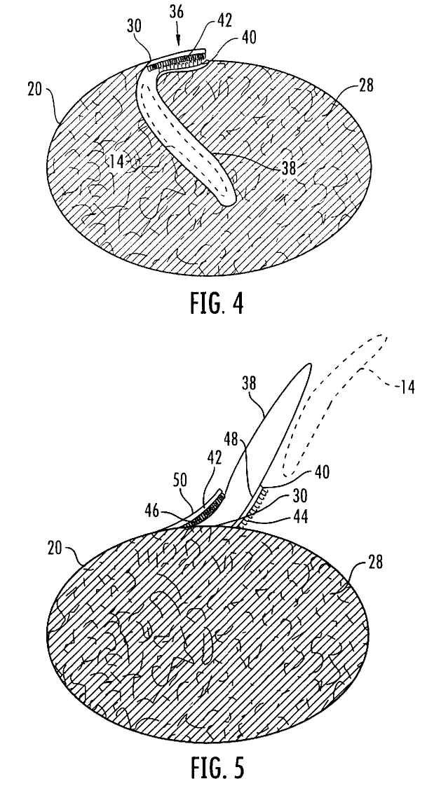

The closure 36 is advantageously a hook and loop closure, such as Velcro™. The closure 36 includes a hook tape 40 and a loop tape 42. Referring to FIGS. 4 and 5, the hook tape 40 has a hook surface 44 including the hook elements. Likewise, the loop tape 42 has a loop surface 46 including the looped material. The hook tape 40 and loop tape 42 have respective reverse surfaces 48, 50.

The hook tape 40 and loop tape 42 are connected along opposite edges of the opening 30. The pouch 30 is connected along both edges of the opening 30. The pouch 38 is also connected to the reverse side 48 of the hook tape 40. As best appreciated from FIG. 5, the hook tape 40 is connected so as to be displaceable through the opening 30 when the pouch 38 is at least partially removed. In this position, the hook surface 44 is facing away from the pouch 38 and interference between the hook surface 44 and any scented article 14 is minimized.

The loop tape 42 can also be connected to be displaceable through the opening 30, for instance in a similar fashion to the hook tape 40. Alternately, the loop tape 42 can be connected, for example by connection to the interior surface of the body 20, such that the loop surface is not displaceable through the opening 30.

In operation of the system 10, referring to FIGS. 1-5, the scented article 14 is scented, preferably through contact with a human familiar to the animal for whom the system is to be used. Any article capable of fitting within the pouch 38 can be used. However, socks or undergarments, due to their relatively close contact with the skin and thereby greater likelihood to absorb scent, are preferred.

The closure 36 is opened and the pouch 38 is at least partially withdrawn through the opening 30. The hook surface 40 is displaced through the opening 30 and is facing away from the pouch 38. The scented article 14 is placed against the pouch 38 and, together with the pouch 38, inserted back into the body 20 through the opening 30. The closure 36 is closed and the article 12 is placed adjacent to the animal.

From the foregoing, it will be appreciate that this embodiment of the present invention provides an article 12 that is readily carried by an animal and provides a comfortable pad or pillow to the animal, when desired. Additionally, the pouch 38 can accommodate a wide variety of articles, to the convenience of the human counterpart of the animal. Moreover, the pouch 38 is configured to allow such articles to be quickly and securely concealed within the body 20, while still allowing the scent of the article 14 to be dispersed through the body 20. Thus, an animal is much less likely to damage the article while trying to retrieve the article 14.

The foregoing embodiment is provided for illustrative purposes. The present invention is not necessarily limited to such an embodiment. Instead, those skilled in the art will understand that numerous modifications, and adaptations to particular circumstances, are possible within the scope of the present invention.

For example, in the view of FIG. 1, the body 20 is in the shape of an animal. It will be appreciated that the present invention is not necessarily limited to such a shape, and that other recognizable and non-recognizable shapes may be used. However, it is advantageous to select shapes and colors that are appealing to the animal using the animal therapy article, its human counterpart or both.

Additionally, while the neck portion 22 advantageously provides a comfortable location for many animals, such as dogs, to cradle their mouth or head, the present invention is not necessarily limited to bodies having neck portions, or to neck portions having the disclosed dimensions. Moreover, the term “neck portion” is not necessarily limited to describing a portion between recognizable head and chest portions, but can describe any portion of reduced-circumference between body sections having substantially greater circumferences. Also, “circumference” does not necessarily refer to a strictly circular measurement, and should be understood to encompass the distance around other, non-circular shapes.

The present invention is not necessarily limited to particular materials for the body or the filling. However, it is advantageous to select materials that are washable, and sufficiently durable and safe for the animal using the animal therapy article.

Also, the present invention is not necessarily limited to any particular size, number or configuration of openings or corresponding closures and pouches. For instance, multiple openings could be defined in the body, each having a separate closure and pouch. Additionally, in addition to having two relatively straight edges, openings with curved edges, triangular edges, or other shapes could be used.

The pouch 38 is advantageously formed from a material having a mesh weave, such as sachet cloth. The use of a mesh weave increases the ease with which the scent of the scented article 14 disperses throughout the body 20. However, the present invention is not necessarily limited to the use of a mesh weave, or other breathable fabric for the pouch 38. Where a hook and loop closure 36 is used, the pouch material is advantageously selected for low- or no susceptibility to gripping by the hook surface 44. The present inventor has found a blend of approximately fifty percent cotton and fifty percent polyester is substantially insusceptible to gripping by the hook surface, even in a mesh weave or sachet cloth.

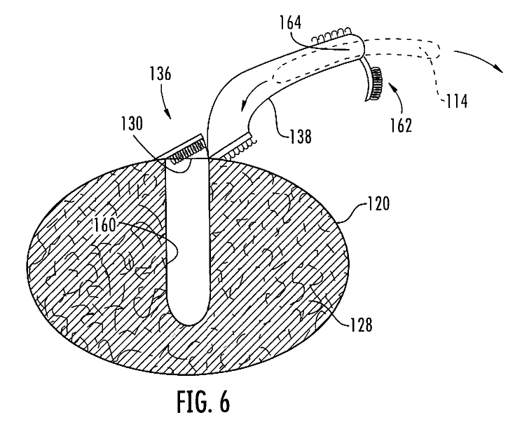

Moreover, the present invention is not necessarily limited to a particular pouch type or configuration. Referring to FIG. 6, in an alternate embodiment, a body 120 includes filling 128. An opening 130 is releasably closed by a closure 136. A pouch 138 is at least partially removable, and may be completely detachable, from the body 120, through the opening 130. A lining 160 extends into the interior volume of the body 120 from the edges of the opening 130.

A pouch closure 162 is formed on an end of the pouch 138 away from the opening 130, relative to the pouch 138 at least partially removed. The pouch closure 162 releasably closes a pouch opening 164, allowing a scented object 114 to be inserted into the pouch 138, which is then readily inserted into the lining 160 within the body 120.

Additionally, the present invention is not necessarily limited to hook and loop closures. Other types of closures can be employed, such as zippers or snaps, for example. However, some types of closures, such as closures formed of metal and having sharp edges, may present a cutting hazard to animals if sniffing or pawing around the closure. Also, for hook and loop closures, the present invention is not necessarily limited to the tape configurations disclosed herein, although such tape configurations advantageously minimize unwanted adhesion between the hook surface and the pouch and scented article.

The foregoing is not an exhaustive list of modifications or adaptations. Rather, those skilled in the art will appreciate that these and other modifications and adaptations are possible within the scope of the invention herein shown and described.

What is claimed is:

1. An animal therapy article comprising:
a body defining an inner volume and an opening in communication with the inner volume;
a hook and loop closure for releasably closing the opening,
filling arranged in the inner volume; and
a pouch arranged in the inner volume and at least partially removable from the body through the opening;
wherein the hook and loop closure has a hook tape with a hook surface and a reverse surface and a loop tape with a loop surface and a reverse surface, and the pouch is attached to the reverse surface of the hook tape.

2. The article of claim 1, wherein the hook and loop tapes are connected adjacent to opposite edges of the opening.

3. The article of claim 2, wherein the hook tape is only connected along an edge of the opening such that the hook tape is displaceable through the opening when the pouch is at least partially removed from the opening.

4. The article of claim 3, wherein the loop tape is connected along an edge of the opening such that the loop tape is displaceable through the opening when the pouch is at least partially removed from the opening.

5. The article of claim 3, wherein the loop tape is connected such that the loop tape is not displaceable through the opening when the pouch is at least partially removed from the opening.

6. The article of claim 1, wherein the body has a neck portion with a circumference and a length, and the neck portion length is at least approximately 10 percent of the neck portion circumference.

7. The article of claim 1, wherein the pouch is formed of a material substantially insusceptible to gripping by the hook surface.

8. The article of claim 1, wherein the pouch defines a pouch opening that is accessible when the pouch is at least partially removed, the pouch opening being releasably closed by a pouch closure.

9. An animal therapy article comprising:
a body defining an inner volume and an opening in communication with the inner volume;
a closure for releasably closing the opening,
filling arranged in the inner volume; and
a pouch arranged in the inner volume and at least partially removable from the body through the opening;
wherein the body has a neck portion with a circumference and a length, and the neck portion length is at least approximately 10 percent of the neck portion circumference.

10. The article of claim 9, wherein the neck portion length is approximately one-eighth of the neck portion circumference.

11. The article of claim 9, wherein the hook and loop closure has a hook tape with a hook surface and a reverse surface and a loop tape with a loop surface and a reverse surface, and the pouch is attached to the reverse surface of the hook tape.

12. The article of claim 9, wherein the pouch is formed of a material substantially insusceptible to gripping by the hook surface.

13. An animal therapy article comprising:
a body defining an inner volume and an opening in communication with the inner volume;
a hook and loop closure for releasably closing the opening,
filling arranged in the inner volume; and
a pouch arranged in the inner volume and at least partially removable from the body through the opening;
wherein the pouch is formed of a material substantially insusceptible to gripping by hooks of the hook and loop closure.

14. The animal therapy article of claim 13, wherein the material is a blend of approximately 50 percent cotton and approximately 50 percent polyester.

15. The article of claim 13, wherein the material has a mesh weave.

16. The article of claim 15, wherein the material is sachet cloth.

17. An animal therapy system comprising:
a body defining an inner volume and an opening in communication with the inner volume;
a closure for releasably closing the opening;
filling arranged in the inner volume;
a pouch arranged in the inner volume and at least partially removable from the body through the opening; and
a scented article removably disposed within the pouch.

18. The system of claim 17, wherein the body has a neck portion with a circumference and a length, and the neck portion length is at least approximately 10 percent of the neck portion circumference.

19. The system of claim 17, wherein the closure is a hook and loop closure having a hook tape with a hook surface and a reverse surface and a loop tape with a loop surface and a reverse surface, and the pouch is attached to the reverse surface of the hook tape.

20. The system of claim 17, wherein the pouch is formed of a material substantially insusceptible to gripping by the hook surface.

21. The system of claim 17, wherein the article is at least one of a sock or an undergarment.

22. The system of claim 17, wherein the scented article is scented with a human scent familiar to the animal.

23. An animal therapy method comprising:
scenting an article with a scent familiar to an animal;
opening a closure on an animal therapy article having a pouch disposed internally thereto;
at least partially withdrawing the pouch through the opened closure;
inserting the scented article into the animal therapy article within the pouch;
closing the closure; and
placing the animal therapy article adjacent to the animal.

24. The method of claim 23, wherein scenting the article includes wearing the article on a human familiar to the animal.

25. The method of claim 23, wherein opening the closure includes disconnecting hook and loop surfaces of a hook and loop closure.

26. The method of claim 25, wherein at least partially withdrawing the pouch includes moving the hook surface to face away from the loop surface.
